(19) United States
(12) Patent Application Publication
(10) Pub. No.: US 2026/0364992 A1
(43) Pub. Date: Nov. 19, 2026

(54) THERMAL REGULATION DEVICE, IN PARTICULAR FOR A MOTOR VEHICLE

(71) Applicant: VALEO ELECTRIFICATION, Cergy (FR)

(72) Inventors: Gael DURBECQ, Le Mesnil-Saint-Denis Cedex (FR); Kamel AZZOUZ, Le Mesnil-Saint-Denis Cedex (FR); Moussa NACER-BEY, Le Mesnil-Saint-Denis Cedex (FR)

(73) Assignee: VALEO ELECTRIFICATION, Cergy (FR)

(21) Appl. No.: 19/515,514

(22) PCT Filed: Sep. 2, 2024
(86) PCT No.: PCT/EP2024/074401

§ 371 Date: Mar. 2, 2026

(30) Foreign Application Priority Data
Sep. 4, 2023 (FR) FR2309284

(51) Int. Cl. B60H 1/00; B60H 1/32

(52) U.S. Cl. CPC B60H 1/00485; B60H 1/00278; B60H 1/32284

(57) ABSTRACT

A thermal regulation device including a circuit of first heat-transfer fluid which includes a distribution system having a plurality of distribution orifices for distributing the first heat-transfer fluid, and a plurality of branches respectively connected to one of the distribution orifices. The distribution system is intended to make at least some of the branches communicate with one another according to various configurations of the system, and includes a distributor member intended to be rotationally movable about a longitudinal axis to selectively serve the branches that are to be made to communicate with one another depending on angular positions. The circuit of first heat-transfer fluid is configured to dissipate or supply heat at an energy storage system exchanger, or an electric system exchanger, using, in addition to the distribution system, only two pumps and relying solely on an exchange of heat at a bi-fluid exchanger and a first external exchanger.

### TECHNICAL FIELD OF THE INVENTION

The invention relates to a thermal regulation device, in particular for a motor vehicle.

### TECHNICAL BACKGROUND

Fluid circuits are known that allow thermal conditioning of different members or zones of a motor vehicle, in particular its batteries and/or its passenger compartment. With the increasing number of hybrid or electric drive systems, these circuits have numerous branches in order to allow the needs for thermal management of the vehicle to be met in various operating modes.

In order to circulate the fluid in their different branches, such circuits comprise a large number of valves that connect the branches to each other according to different configurations depending on the desired operating mode. Such a number of valves increases the pressure losses. In addition, they make controlling the circulation of the fluid more complex and increase the cost of these circuits.

Rotary valves have also been proposed, such valves allowing numerous inlets/outlets to be connected in order to offer more possibilities for circulating the fluid between the branches of the circuit compared to the standard two-, three-, or four-way valves. However, there remains a need to improve the associated circuits in order to limit the complexity thereof while retaining a large number of possible operating modes.

### SUMMARY OF THE INVENTION

The present invention aims to at least partially overcome the aforementioned drawbacks and to this end proposes a thermal regulation device comprising a circuit of first heat transfer fluid, said circuit of first heat transfer fluid comprising a system for distributing said first heat transfer fluid having a plurality of orifices for distributing said first heat transfer fluid, said circuit of first heat transfer fluid further comprising a plurality of branches respectively connected to one of said distribution orifices, said distribution system being intended to place at least some of said branches in communication with each other according to different configurations of said system, said distribution system comprising a distribution member, said distribution member being intended to be able to rotate about a longitudinal axis in order to selectively feed said branches to be placed in communication with each other as a function of angular positions of said distribution member,
a first of said branches comprising a heat exchanger, referred to as the electrical storage system heat exchanger,
a second of said branches being connected to a so-called two-fluid exchanger, intended to exchange heat with a refrigerant,
a third of said branches comprising an exchanger, referred to as the first exterior exchanger, intended to exchange heat with a second heat transfer fluid,
a fourth of said branches comprising a first pump and, optionally, a heat exchanger, referred to as the electrical system heat exchanger,
a fifth of said branches being connected to said two-fluid exchanger,
a sixth of said branches comprising a second pump, said circuit of first heat transfer fluid being configured to dissipate or supply heat in said electrical energy storage system exchanger or, if applicable, said electrical system exchanger, using only one and/or the other of said two pumps and heat exchange in said two-fluid exchanger and/or said first exterior exchanger.

Two-fluid exchanger is given to mean an exchanger that allows heat exchange between a heat transfer fluid and a refrigerant.

The invention, using a single valve, in this case the multi-way distribution system, no more than two pumps, and a single two-fluid exchanger, and without using heat exchange between different loops of heat transfer fluid, makes it possible to limit the complexity of the circuit of first heat transfer fluid and the pressure losses, while still allowing a large number of operating modes. The above does not however rule out the presence of heat exchangers intended to exchange heat between the first heat transfer fluid and a heat transfer fluid circulating in a circuit dedicated to the members for which thermal regulation is required, such as one or more dedicated circuits for the electrical energy storage system and/or the electrical system.

The device according to the invention can further comprise one or more of the features below, taken in isolation from one another or in combination with one another:
said circuit of first heat transfer fluid is configured so that said first fluid circulates from and to the distribution system, passing through said two-fluid exchanger without passing through one of the pumps,
a seventh of said branches is configured to bypass the third branch,
said circuit of first heat transfer fluid is configured so that one of the angular positions of the distribution member, referred to as the first position, makes it possible to form a first loop comprising said first, second, fifth, and sixth branches and a second loop comprising said third and fourth branches,
said first branch or said sixth branch further comprises a so-called electric heat exchanger, intended to heat said first fluid using an electric current,
the device is configured so that said sixth branch supplies said first branch with first heat transfer fluid in all of the angular positions of said distribution member,
said device comprises a divergence point, situated at a first end of said fourth branch,
said first end of the fourth branch is opposite a second end of said fourth branch connected to said distribution system,
said divergence point is connected to said third branch and to said seventh branch,
said device is configured so that said first heat transfer fluid is a cooling liquid,
said device is configured so that said second heat transfer fluid is a first air stream, referred to as the exterior air stream,
said device comprises a refrigerant circuit,
said refrigerant circuit comprises said two-fluid exchanger,
said refrigerant circuit comprises a main loop comprising, in a direction of circulation of said refrigerant in said main loop, a compressor, an exchanger, referred to as the first interior exchanger, and said two-fluid exchanger, said first interior exchanger being intended to exchange heat between said refrigerant and a second air stream, referred to as the interior air stream, said main loop comprises a so-called main branch, provided with said compressor and said first interior exchanger,
said refrigerant circuit comprises a first bypass branch, situated in parallel with said main branch, said first bypass branch comprising an exchanger, referred to as the second exterior exchanger, intended to exchange heat between said refrigerant and said exterior air stream,
said refrigerant circuit comprises a second bypass branch, situated in parallel with said main branch, said second branch comprising an exchanger, referred to as the second interior exchanger, intended to exchange heat between said refrigerant and said interior air stream,
said refrigerant circuit comprises a third bypass branch, said device being configured so that the refrigerant circulates in series in said main branch, in a portion comprising said second exterior exchanger of said first bypass branch, and in said third bypass branch,
said distribution member comprises a body having:
   a first fluid distribution channel, extending axially along the longitudinal axis, and
   a first chamber in communication with said first distribution channel, said first chamber opening radially,
such that angular positions of said body determine a passage for the fluid between a so-called axial inlet and/or outlet channel and at least one from among so-called peripheral inlet and/or outlet channels of the distribution system, through the first chamber and the first distribution channel,
the first distribution channel is centered on the longitudinal axis, the first chamber is intended to be in communication with no more than one of the peripheral channels, whatever the angular position of the body,
the body has one or more second chambers opening radially such that angular positions of said body determine a passage for the fluid between different of said peripheral inlet and/or outlet channels of said distribution system, through the or at least one of the second chamber or chambers,
the first and/or second chambers extend angularly about the longitudinal axis,
the body comprises arms connected to each other through a central portion, said arms extending from said central portion to lateral edges of said body, said arms defining at least one of said chambers, said distribution system forms a valve,
said valve comprises a casing defining a housing for said distribution member, said casing being provided with said peripheral inlet and/or outlet channels.

### BRIEF DESCRIPTION OF THE FIGURES

Further features and advantages of the invention will become apparent on reading the following detailed description, which will be more clearly understood with reference to the appended drawings, in which:

FIG. 1 schematically shows an example of a regulation device according to the invention, used according to a first operating mode,

FIG. 2 schematically shows a second operating mode of the regulation device in FIG. 1,

FIG. 3 schematically shows a third operating mode of the regulation device in FIG. 1,

FIG. 4 schematically shows a fourth operating mode of the regulation device in FIG. 1,

FIG. 5 schematically shows a fifth operating mode of the circuit in FIG. 1,

FIG. 6 schematically shows, in perspective, an example of a distribution member of a distribution system of a thermal regulation device according to the invention,

FIG. 7 schematically shows, in a transverse section plane, the distribution member in FIG. 6,

FIG. 8 is an exploded view of distribution system comprising the distribution member in FIG. 6,

FIG. 9 schematically shows, in perspective, the distribution system in FIG. 8,

FIG. 10 is an exploded view of another distribution system comprising the distribution member in FIG. 6,

FIG. 11 schematically shows, in an axial section plane, the distribution system in FIG. 10.

In these figures, the same reference sign corresponds to identical or similar elements.

### DETAILED DESCRIPTION OF THE INVENTION

Firstly, it will be noted that the terms upstream and downstream used in the following description relate to the direction of circulation of the fluid in question. In addition, the terms “first”, “second”, “third”, etc., are used solely to distinguish the components in question from each other, and do not indicate any order or any potential importance of said components.

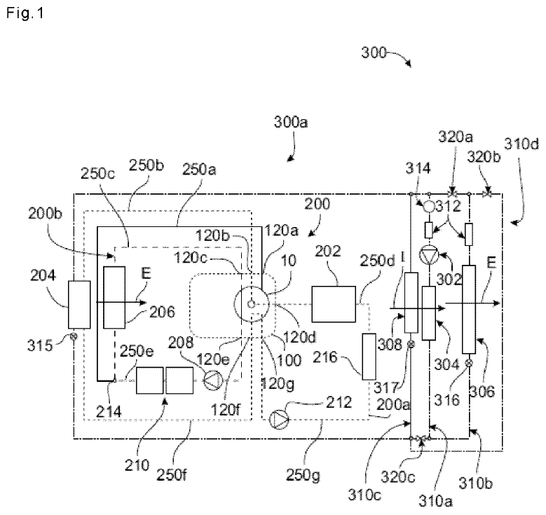

As shown in FIGS. 1 to 5, the invention relates to a thermal regulation device. It is intended, in particular, for motor vehicles, particularly electric motor vehicles. It is for example used for the thermal regulation of different members or zones of motor vehicles, particularly the batteries, the drive system, and/or the passenger compartment thereof.

Said thermal regulation device comprises a circuit 200 of first heat transfer fluid. Said first heat transfer fluid is for example a liquid, in particular a mixture of water and an antifreeze product such as glycol. Alternatively, it is for example a dielectric fluid such as oil.

Said circuit 200 of first heat transfer fluid comprises a system 100 for distributing said first heat transfer fluid and a plurality of branches 250a-250g respectively connected to one among distribution orifices 120a-120g of said distribution system.

Said distribution system 100 is intended to place at least some of said branches 250a-250g in communication with each other according to different configurations of said system. For this, said distribution system comprises a distribution member 10 in order to selectively feed said branches 250a-250g to be placed in communication with each other as a function of positions, in particular angular positions, of said distribution member 10. To this end, said distribution member 10 is preferably intended to able to rotate about a longitudinal axis.

In said circuit 200 of first heat transfer fluid:
a first 250d of said branches, connected to a first 120d of the communication orifices, comprises a heat exchanger 202, referred to as the electrical energy storage system heat exchanger,
a second 250b of said branches, connected to a second 120b of the communication orifices, is connected to a so-called two-fluid exchanger 204, intended to exchange heat with a refrigerant,
a third 250c of said branches, connected to a third 120c of the communication orifices, comprises an exchanger 206, referred to as the first exterior exchanger, intended to exchange heat with a second heat transfer fluid, identified here by an arrow denoted E,
a fourth 250e of said branches, connected to a fourth 120e of the communication orifices, comprises a first pump 208 and, optionally, a heat exchanger 210, referred to as the electrical system heat exchanger,
a fifth 250f of said branches, connected to a fifth 120f of the communication orifices, is connected to said two-fluid exchanger 204,
a sixth 250g of said branches, connected to a sixth 120g of the communication orifices, comprises a second pump 212.

Electrical energy storage system heat exchanger 202 is given to mean an exchanger that allows direct or indirect heat exchange with said storage system.

In other words, according to a first variant, said storage system heat exchanger 202 is incorporated into said storage system and allows the first heat transfer fluid to pass through said storage system, cooling it or heating it. Said first heat transfer fluid is in this case preferably a dielectric fluid so that it can be placed in contact with the electrical components of said storage system.

According to another variant, said device comprises a circuit of a first specific fluid for thermally regulating said storage system. Said circuit of first specific fluid comprises said storage system heat exchanger 202 and said storage system, as well as a first specific pump for driving said first specific fluid. Said storage system exchanger 202 is in this case intended to exchange heat between said first heat transfer fluid and said first specific fluid. Said first specific fluid is in this case preferably a dielectric fluid, and the first heat transfer fluid is advantageously water with the addition of antifreeze, subject to the method of heat exchange with said electrical system, as set out below.

Said storage system is for example made up of one or more electric batteries.

Electrical system heat exchanger 210 is given to mean an exchanger that allows direct or indirect heat exchange with said electrical system.

In other words, according to a first variant, said electrical system heat exchanger 210 is incorporated into said electrical system and allows the first heat transfer fluid to pass through said electrical system, cooling it or heating it. Said first heat transfer fluid is in this case preferably a dielectric fluid so that it can be placed in contact with the electrical components of said electrical system.

According to another variant, said device comprises a circuit of a second specific fluid for thermally regulating said electrical system. Said circuit of second specific fluid comprises said electrical system heat exchanger 210 and said electrical system, as well as a second specific pump for driving said second specific fluid. Said electrical system exchanger 210 is in this case intended to exchange heat between said first heat transfer fluid and said second specific fluid. Only said second specific fluid is in this case preferably a dielectric fluid, and the first heat transfer fluid is advantageously water with the addition of antifreeze, subject to the method of heat exchange with said electrical energy storage system, as set out above.

Said electrical system comprises for example an electric machine used to drive the vehicle and/or an electronic system for controlling said electric machine.

Said device is configured so that said second heat transfer fluid is, for example, a first air stream, referred to as the exterior air stream. Said first exterior exchanger 206 is intended to be situated, in particular, on a front face of the vehicle so that said exterior air stream E can pass through it, said exterior air stream E having first passed through a grille of the vehicle. Said first exterior exchanger 206 is formed, for example, by a low-temperature radiator.

According to the invention, in the absence of said electrical system exchanger 210, said circuit 200 of first heat transfer fluid is configured to dissipate or supply heat in said energy storage system exchanger 202, using only one and/or the other of said two pumps 208, 212 and heat exchange in said two-fluid exchanger 204 and/or said first exterior exchanger 206, as a function of the desired operating mode.

In the presence of said electrical system exchanger 210, said circuit 200 of first heat transfer fluid is configured to dissipate or supply heat, in said energy storage system exchanger 202 and/or said electrical system exchanger 210, using only one and/or the other of said two pumps 208, 212 and heat exchange in said two-fluid exchanger 204 and/or said first exterior exchanger 206, as a function of the desired operating mode.

In other words, in said circuit 200 of first heat transfer fluid, whatever the operating mode, said first and second pumps 208, 212 are the only pumps, said two-fluid exchanger 204 is the only two-fluid exchanger, and there is no heat exchange between the first heat transfer fluid and one or more other heat transfer fluids, apart from with any circuits dedicated to the members for which thermal regulation is required, such as the specific fluid circuits mentioned above. In addition, said distribution system 100 is the only valve of the circuit 200 of first heat transfer fluid, which means that said circuit 200 of first heat transfer fluid does not comprise other valves in order to connect its different branches to be placed in communication with each other, or even a non-return valve.

As a result, the complexity of the circuit 200 of first heat transfer fluid and the pressure losses in said circuit 200 are limited, while retaining great flexibility in terms of operating mode by virtue of said multi-way distribution system.

Advantageously, there are seven branches of said circuit 200 of first fluid. By correlation, there are seven distribution orifices 120a-120g of the distribution system.

In the example shown, the seventh 250a of said branches of the circuit 200 of first fluid, connected to the seventh 120a of the communication orifices, is configured to bypass the third branch 250c.

Here, said device comprises a divergence point 214, situated at a first end of said fourth branch 250e. Said first end of the fourth branch 250e is opposite a second end of said fourth branch 250e connected to said distribution system 100 at its fourth distribution orifice 120e. Said divergence point is connected to said third branch 250c and to said seventh branch 250a respectively, by one of their ends opposite the end connected to said distribution system 100 at its third and seventh distribution orifices 120c, 120a. The first heat transfer fluid arriving at the divergence point 214 can therefore, as a function of the positions of the distribution member 10, either pass through the first exterior exchanger 206 by taking the third branch 250c, or bypass said first exchanger 206 by taking said seventh branch 250a, before returning to said distribution system 100.

In said fourth branch 120e, the first pump 208 and said electrical system exchanger 210 are situated in series in that order in the direction of circulation of said first heat transfer fluid from said fourth distribution orifice 120e toward said divergence point 214.

Preferably, said circuit 200 of first heat transfer fluid is configured so that said first fluid circulates in said second and fifth branches 250b and 250f, from and to the distribution system 100, passing through said two-fluid exchanger 204 without passing through either of the pumps 208, 212.

Preferably again, said circuit 200 of first heat transfer fluid is configured so that one of the angular positions of the distribution member, referred to as the first position, makes it possible to form a first loop 200a comprising said first, second, fifth, and sixth branches 250d, 250b, 250f, 250g and a second loop 200b comprising said third and fourth branches 250c, 250e. Such a configuration will be described below with reference to FIG. 1.

More preferably, said device is configured so that said sixth branch 250f supplies said first branch 250d with first heat transfer fluid in all of the angular positions of said distribution member 10. In other words, said second pump 212 is situated upstream of said electrical energy storage system exchanger 202 in the direction of circulation of said first heat transfer fluid in said first and sixth branches 250d, 250g.

According to the exemplary embodiment shown, said first branch 250d or said sixth branch 250g further comprises a so-called electric heat exchanger 216, intended to heat said first fluid using an electric current. Here, it is situated between said second pump 212 and said electrical energy storage system exchanger 202 in the direction of circulation of the first heat transfer fluid in said first branch and sixth branch 250d, 250g.

Preferably, said device further comprises a refrigerant circuit 300. Said refrigerant circuit 300 is configured to perform a thermodynamic cycle, in particular having a compression phase, a first heat exchange phase, an expansion phase, and a second heat exchange phase. Said refrigerant circuit 300 comprises said two-fluid exchanger 204.

The refrigerant is, for example, a sub-critical fluid, such as those known by the name R134a or R1234yf. As a variant, it is a super-critical fluid such as CO2 or R744. As a further variant, it is propane.

Here, said refrigerant circuit comprises a main loop 300a. Said main loop 300a comprises, in a direction of circulation of said refrigerant in said main loop, a compressor 302, an exchanger 304, referred to as the first interior exchanger, and said two-fluid exchanger 204. Said first interior exchanger 304 is intended to exchange heat between said refrigerant and a second air stream, referred to as the interior air stream, identified by an arrow denoted I. Said interior air stream I is intended to circulate in the passenger compartment for the thermal regulation thereof. Said first interior exchanger 304 is configured to be positioned in a heating, ventilation and/or air conditioning unit positioned for example under a dashboard of the vehicle. It is for example an interior condenser.

Said main loop 300a comprises a so-called main branch 310a, provided with said compressor 302 and said first interior exchanger 304.

Here, said refrigerant circuit 300 further comprises a first bypass branch 310b, situated in parallel with said main branch 310a in said loop 300a. Said first bypass branch 310b comprises for example an exchanger 306, referred to as the second exterior exchanger, intended to exchange heat between said refrigerant and said exterior air stream E.

Said second exterior exchanger 306 is intended to be situated, in particular, on the front face of the vehicle so that said exterior air stream E can pass through it, said exterior air stream E having first passed through the grille of the vehicle. Said second exterior exchanger 306 is for example formed by an exterior evaporator/condenser. It is intended to be situated in series or in parallel with the first exterior exchanger 206 in said exterior air stream E, for example upstream of said first exterior exchanger 206 in the direction of circulation of said exterior air stream E.

Here, said refrigerant circuit 300 further comprises a second bypass branch 310c, situated in parallel with said main branch 310a in said main loop 300a. Said second bypass branch comprises an exchanger 308, referred to as the second interior exchanger, intended to exchange heat between said refrigerant and said interior air stream I. Said second interior exchanger 304 is configured to be positioned in the heating, ventilation and air conditioning unit. It is for example situated upstream of said first interior exchanger 308 in the direction of circulation of said interior air stream I. It is for example an evaporator.

Here, said refrigerant circuit 300 further comprises a third bypass branch 310d, said device being configured so that the refrigerant circulates in a loop comprising, in series, said main branch 310a, a portion comprising said second exterior exchanger 306 of said first bypass branch 310b, said third bypass branch 310d, and a portion of said main loop comprising said two-fluid exchanger 204. Such circulation of the refrigerant corresponds to that shown in FIG. 1 in particular.

Here, said refrigerant circuit 300 further comprises first, second, and third expansion members 315, 316, 317, respectively associated with the two-fluid exchanger 204, in the main loop 300a, with the second exterior exchanger 306, in the first bypass branch 310b, and with the second interior exchanger 308, in the second bypass branch 310c. Said expansion members are advantageously configured to interrupt the circulation of the refrigerant as necessary.

In the example shown, said refrigerant circuit 300 further comprises a so-called refrigerant exchanger 312, configured to allow heat exchange between the refrigerant and itself. To this end, the refrigerant passes through said refrigerant exchanger 312 in respective passes, being at different pressure levels in each pass, before entering the compressor 302 again. One of the passes, namely the high-pressure pass, is in the first bypass branch 310b. Another of the passes, namely the low-pressure pass, is in the main branch 310a.

Said refrigerant circuit 300 further comprises an accumulator 314, making it possible to store said refrigerant. Here, said accumulator is situated in said main branch 310a downstream of said refrigerant exchanger and upstream of said compressor 302 in the direction of circulation of the refrigerant in said main loop 300a.

Said refrigerant circuit 300 further comprises different valves 320a, 320b, 320c allowing the refrigerant to circulate in the main loop and in said first, second, and/or third bypass branches according to the desired operating modes.

The device according to the invention allows a very large number of operating modes by virtue of the different positions of the distribution member 10.

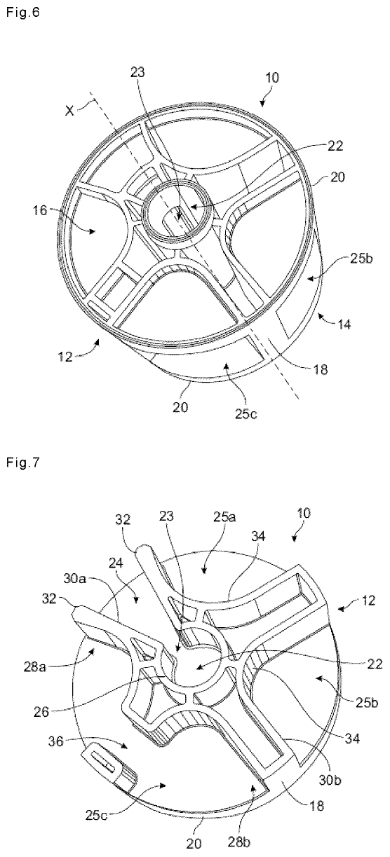

Before some of these are described, an example of a distribution system 100 and the distribution member 10 thereof, configured to be used in the device according to the invention, are described below, with reference to FIGS. 6 to 11.

In FIG. 6, the longitudinal axis about which said distribution member 10 is intended to be able to rotate is denoted X. The distribution member 10 comprises a body 12 and can optionally comprise a first plate 14 and a second plate 16, which are parallel and orthogonal to the longitudinal axis X, connected by the body 12. The body 12 has lateral edges 18, which in the present example are situated on a notional cylinder connecting peripheral edges 20 of the plates 14, 16. It will be understood that the first and second plates 14, 16, where present, define a diameter of the distribution member 10.

The distribution member 10 can be configured to rotate in a clockwise and/or anticlockwise direction. The distribution member 10 can be configured to rotate through more than 360°.

The body 12 of the distribution member 10 further has a first fluid distribution channel 22. This first distribution channel 22 extends axially along the longitudinal axis X. This is given to mean that the longitudinal axis X of rotation of the distribution member 12 passes through the distribution channel 22. Advantageously, the first distribution channel 22 is centered on the longitudinal axis X.

The body 12 also has a first chamber 24 in communication with the distribution channel 22. This first chamber 24 also opens radially.

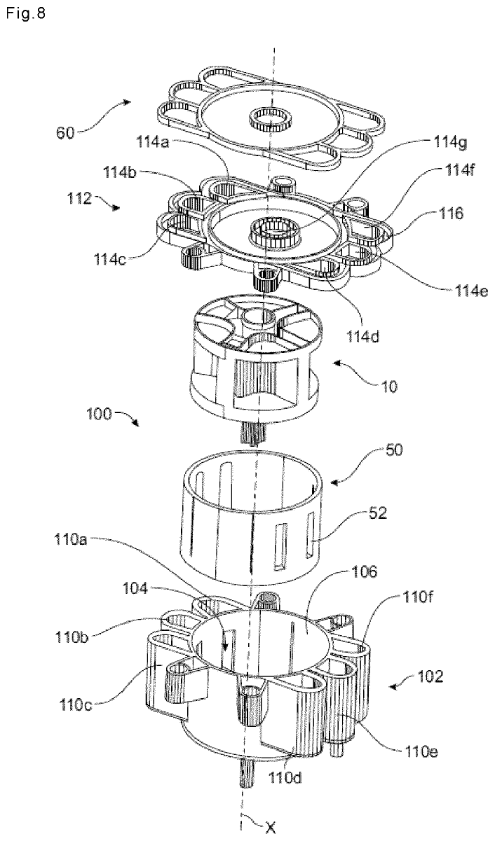

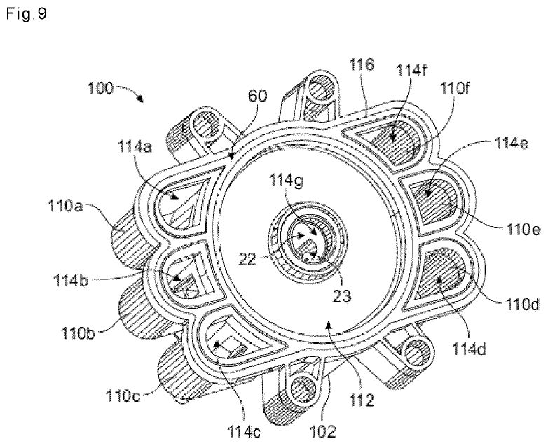

As a result, the angular positions of the body 12 that the distribution member 10 can adopt can determine a passage for the fluid between a so-called axial inlet and/or outlet channel 108, and at least one from among so-called peripheral inlet and/or outlet channels 110a-110f of the distribution system 100 (see FIGS. 8 to 11), through the first chamber 24 and the first distribution channel 22.

The body 12 of the distribution member 10 can further have one or more second chambers 25a-25c opening radially such that at least some of the angular positions of the body 12 that the distribution member 10 can adopt also determine a passage for the fluid between different of the peripheral inlet and/or outlet channels 110a-110f of the valve 100, through the or at least one of the second chamber or chambers 25a-25c. In the examples shown, there are three second chambers 25a-25c.

The first chamber 24 and/or said second chamber or chambers 25a-25c advantageously extend angularly about the longitudinal axis X.

The distribution member 10, in particular the body 12, has a height h extending along the longitudinal axis X. It will be understood that the height h corresponds to a height of the first chamber 24 and, when they exist, of the second chamber or chambers 25a-25c.

Advantageously, the first distribution channel 22 is in communication with the first chamber 24 over all or part of the height h of the first chamber 24. This communication between the distribution channel 22 and the first chamber 24 takes place by means of an opening 23. In addition, the distribution member 10, in particular the body 12, advantageously comprises a central portion 26. The body 12 can also comprise arms 28a, 28b connected to each other through the central portion 26. The arms advantageously extend substantially radially from the central portion to the lateral edges 18.

The chamber or chambers 24, 25a-25c is/are defined between two of the arms. In other words, when the distribution member 10 comprises a plurality of chambers 24, 25a-25c, the arms separate the chambers 24, 25a-25c from each other.

The arms 28a, 28b comprise walls 30a, 30b that extend along the longitudinal axis X from the first plate 14 toward the second plate 16.

The walls 30a of the arms 28a defining the first chamber 24 can be substantially planar. These arms 28a can further comprise outer ends, that is, opposite the central portion 26, having a bevel 32.

Here, the angular amplitude of the first chamber 24 is between 35 and 45 degrees. The arms 28b defining at least one of the second chambers 25a-25c can form a curved base 34 on the central portion 26. This curved base 34 can be concave in order to facilitate the flow of the fluid.

Here, the angular amplitude of each second chamber 25a-25c is between 70 and 90 degrees.

Advantageously, at least one of the arms 28b comprises a through-channel 36 configured to connect one of the chambers with another of the adjacent chambers, as shown more particularly in FIG. 7. With reference to the example shown, it will be understood that the chamber 25c is composed of two half-chambers connected to each other by the through-channel 36 to form an enlarged chamber, corresponding to the chamber 25c.

As shown in FIGS. 8 to 11, here, the distribution system 100 is formed by a valve. The valve comprises a casing 102 defining a housing 104 for the distribution member 10. It will be understood that in this case the housing 104 has a diameter that is substantially identical to the diameter of the distribution member 10, with a clearance necessary for the rotation of the distribution member 10 in the housing 104. The lateral edges 18 of the body 12 are situated facing and in the immediate vicinity of, allowing for the clearance, an inner face of a lateral wall 106 of the casing 102.

The casing 102 is provided with peripheral inlet and/or outlet channels 110 opening laterally into the housing 104. In the examples shown, there are six peripheral inlet and/or outlet channels 110a-110f, namely a first inlet and/or outlet channel 110a, a second inlet and/or outlet channel 110b, a third inlet and/or outlet channel 110c, a fourth inlet and/or outlet channel 110d, a fifth inlet and/or outlet channel 110e, and a sixth inlet and/or outlet channel 110f.

Each of the peripheral inlet and/or outlet channels 110a-110f is formed as a radial protuberance of a lateral wall 106 of the casing 102. Advantageously, the peripheral inlet and/or outlet channels 110a-110f are distributed in two diametrically opposed groups. It will be understood, with reference to the figures, that a first group of peripheral inlet and/or outlet channels 110a-110c is positioned on one side of the casing, while a second group of peripheral inlet and/or outlet channels 110d-110f is positioned diametrically opposite the first group. Each of the first and second groups can comprise three of the peripheral inlet and/or outlet channels 110a-110f. The peripheral inlet and/or outlet channels 110a-110f of a group here extend over an angular interval of no more than 120 degrees.

As a function of its angular position, the first chamber 24 of the distribution member is or is not placed in communication with one or more of said peripheral inlet and/or outlet channels. Said first chamber 24 is intended to be in radial communication with the peripheral inlet and/or outlet channels 110a-110f. Advantageously, the first chamber 24 is intended to be in communication with no more than one of the peripheral channels 110a-110f, whatever the angular position of the body 12 of the distribution member 10.

The second chamber or chambers 25a-25c is/are in radial communication with the peripheral inlet and/or outlet channels 110a-110f. Advantageously, the second chamber or chambers 25a-25c is/are in communication with no more than two of the peripheral inlet and/or outlet channels 110a-110f, whatever the angular position of the body 12 of the distribution member 10.

The valve 100 can comprise an actuator (not shown), for example a stepper motor, for rotating the distribution member 10 about the longitudinal axis X. The distribution member 10 can in this case comprise a drive shaft, intended to be engaged with the actuator.

The valve 100 can also comprise a first annular gasket 50 situated between the distribution member 10 and the inner face of the lateral wall 106 of the casing 102. This first annular gasket 50 advantageously has apertures 52 having an outline that corresponds to an outline of a portion of the peripheral inlet and/or outlet channels 110a-110f that opens into the housing 104. Preferably, the first annular gasket 50 is fixedly mounted.

The valve 100 can further comprise a closure plate 112 that is designed to close the casing 102. This closure plate 112 is mounted orthogonally to the longitudinal axis X of the distribution member 10. The closure plate 112 can be fixed, in particular welded, to the casing 102. In the embodiment in FIGS. 8 and 9, the closure plate 112 is configured to be fixed to a fluid distribution support (not shown), in particular to a case of such a support.

The closure plate 112 advantageously comprises apertures 114a-114g situated in the axial continuation of the first distribution channel 22 and/or of the peripheral inlet and/or outlet channels 110a-110f. The aperture 114a is thus situated in the axial continuation of the channel 110a, the aperture 114b is situated in the axial continuation of the channel 110b, the aperture 114c is situated in the axial continuation of the channel 110c, the aperture 114d is situated in the axial continuation of the channel 110d, the aperture 114e is situated in the axial continuation of the channel 110e, the aperture 114f is situated in the axial continuation of the channel 110f, and the aperture 114g is situated in the axial continuation of the first distribution channel 22. Here, said apertures 114a-114g form the distribution orifices 120a-120g in communication with the branches 250a-250g of the circuit 200 of first heat transfer fluid.

The valve 100 can comprise a second annular gasket 60 configured to provide a seal with the distribution support. In such a case, the closure plate 112 advantageously comprises, on an outer face, a groove 116. This groove 116 is designed to receive the second annular gasket 60. This second gasket 60 can be a flat seal in multiple parts, for example one part around each aperture 114a-114f and one part around the aperture 114g, as shown in the embodiment in FIGS. 8 and 9.

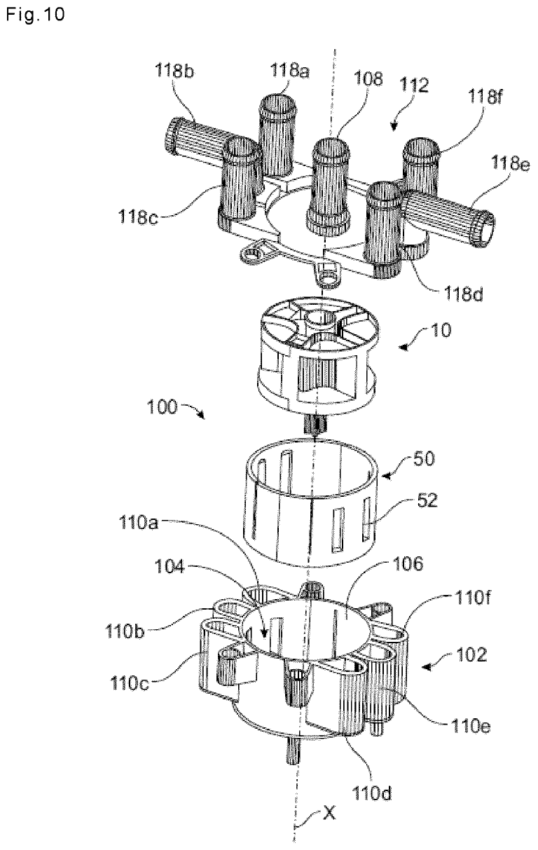

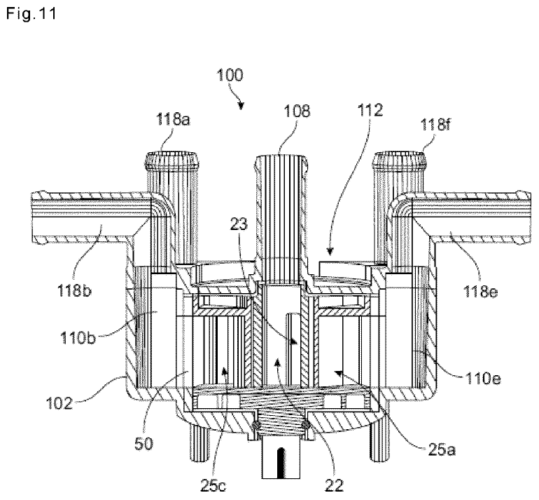

As an alternative, shown in FIGS. 10 and 11, the valve is intended to be used independently, by being connected to hoses for circulating the first fluid. The closure plate 112 comprises an axial inlet and/or outlet duct 108 in communication with the first channel 22. The closure plate can also comprise peripheral inlet and/or outlet ducts 118a-118f in communication, respectively, with the peripheral inlet and/or outlet channels 110a-110f. The axial or peripheral inlet and/or outlet ducts, 108 or 118a-118f, open into the distribution orifices 120a-120g in communication with the branches 250a-250g of the circuit 200 of first heat transfer fluid. They can be oriented along the longitudinal axis X and/or bent.

The closure plate 112 permits interchangeability of the valve 100 according to the type of distribution support used in a circuit of a fluid, in particular a heat transfer liquid.

With reference once more to FIGS. 1 to 5, different operating modes of the device according to the invention will now be described, with reference to respective positions of said distribution member 10.

In FIG. 1, the priority aim of the operating mode shown is to dissipate the heat released by said electrical energy storage system exchanger 202, via said refrigerant circuit 300, and moreover by dedicating the two-fluid exchanger 204 to heat exchange between the refrigerant and the portion of first heat transfer fluid that has passed through said electrical energy storage system exchanger 202. Such an operating mode makes it possible to cool the batteries during the rapid charging phases thereof, when such phases result in significant heating of the batteries due to the electric currents involved in said phases.

More specifically, in this first operating mode, in the first loop 200a of said first circuit 200 of first heat transfer fluid, starting from the sixth distribution orifice 120g, the first heat transfer fluid is driven by the second pump 212, and passes through said electric heat exchanger 216, which is inactive, and said electrical energy storage system heat exchanger 202 before returning to the distribution system 100 by the first distribution orifice 120d. In the angular position in question, said distribution member 10 connects said first distribution orifice 120d to the second distribution orifice 120b. The first heat transfer fluid then continues its route along said first loop 200a, passing through said two-fluid exchanger 204 to return to said distribution system 100 by the fifth distribution orifice 120f. In the angular position in question, said distribution member 10 connects said fifth distribution orifice 120f to the sixth distribution orifice 120g to form said first loop 200a. Through said first loop 200a, the heat released by said electrical energy storage system exchanger 202 into the first heat transfer fluid can thus be transferred to said two-fluid exchanger 204.

In the second loop 200b of said first circuit 200 of first heat transfer fluid, starting from the fourth distribution orifice 120e, the first heat transfer fluid is driven by the first pump 208, passes through said electrical system exchanger 210, passes through said divergence point 214, and then takes the third branch 250c to pass through said first exterior heat exchanger 206 before returning to the distribution system 100 by the third distribution orifice 120c. In the angular position in question, said distribution member 10 connects said third distribution orifice 120c to the fourth distribution orifice 120e to form said second loop 200b. It will be noted that, through said second loop 200b, any heat released by said electrical system exchanger 210 can thus be transferred to said first exterior exchanger 206 by the first heat transfer fluid. This heat can thus be released into the exterior air stream E by said first exterior exchanger 206, without however interfering with the heat released by said electrical storage exchanger 200 202 as the latter is placed on the first loop 200a.

In this first operating mode, it will be understood that the first heat transfer fluid does not circulate in said seventh branch 250a, the seventh distribution orifice 120a not being connected to any other orifice by means of said distribution member 10.

For its part, the refrigerant, starting from the compressor 302, circulates along the main branch 310a, passing through said first interior heat exchanger 304 without however exchanging heat with said interior air stream I, for example using a bypass channel provided to this end in the heating, ventilation and air conditioning unit. Said refrigerant then takes said first bypass branch 310b. To this end, the third valve 320c is placed along said main branch 310a and is in this case closed. In said first bypass branch 310b, said second expansion member 316 is open but inactive. The refrigerant then enters said second exterior exchanger 306, where it condenses. It thus releases the heat that it contains, namely the heat captured in the two-fluid exchanger 204, into said exterior air stream E. On leaving said first bypass branch 310b, it enters said third bypass branch 310d to return to said main loop downstream of said third valve 320c. So that said refrigerant takes said third bypass branch 310d on leaving said first bypass branch 310b, said first bypass branch 310a is provided with the first valve 320a, which is closed in this case, and said third bypass branch 310d is provided with said second valve 320b, which is open in this case. Along said main loop 300a, the refrigerant then passes through the first expansion member 315, which is active, and said two-fluid exchanger 204, evaporating under the effect of the heat released by said first heat transfer fluid and coming from said electrical storage system exchanger 202. Said refrigerant then returns to the compressor 302 for another cycle. It will further be noted that said refrigerant does not circulate in said second bypass branch 310c, said third expansion member 317 being closed.

According to one variant of this first operating mode, the interior air stream I passes through said first interior exchanger 304, which makes it possible to release a first portion of the heat captured by the refrigerant in the two-fluid exchanger 204 into said interior air stream I.

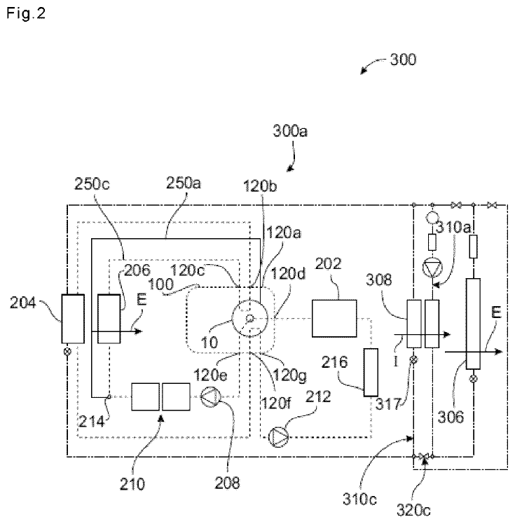

In FIG. 2, the operating mode shown makes it possible to cool said electrical energy storage system exchanger 202 and said electrical system exchanger 210 by placing them on the same loop for circulating said first refrigerant, referred to as the single loop, by placing said two-fluid exchanger 204 and said first exterior exchanger 206 on said single loop. The heat released by said electrical energy storage system exchanger 202 and said electrical system exchanger 210 can thus be dissipated both into the refrigerant, by said two-fluid exchanger 202, and into the exterior air stream E, by said first exterior exchanger 206, via said first heat transfer fluid. In addition, the power of said pumps 208, 212 is combined. Such an operating mode also makes it possible, if necessary, to cool the passenger compartment using said second interior heat exchanger 308.

More specifically, in this second operating mode, in the single loop of first heat transfer fluid, starting from the sixth distribution orifice 120g, the first heat transfer fluid is driven by the second pump 212, passes through said electric heat exchanger 216, which is inactive, and said electrical energy storage system heat exchanger 202 before returning to the distribution system 100 by the first distribution orifice 120d. In the angular position in question, said distribution member 10 connects said first distribution orifice 120d to the fourth distribution orifice 120e. The first heat transfer fluid is then driven by the first pump 208, passes through said electrical system exchanger 210, passes through said divergence point 214, and then takes the third branch 250c to pass through said first exterior heat exchanger 206 before returning to the distribution system 100 by the third distribution orifice 120c. In the angular position in question, said distribution member 10 connects said third distribution orifice 120c to the second distribution orifice 120b and said first heat transfer fluid then continues its route by passing through said two-fluid exchanger 204 to return to said distribution system 100 by the fifth distribution orifice 120f. In the angular position in question, said distribution member 10 connects said fifth distribution orifice 120f to the sixth distribution orifice 120g to form said single loop.

In this second operating mode, as in the preceding mode, it will be understood that the first heat transfer fluid does not circulate in said seventh branch 250a, the seventh distribution orifice 120a not being connected to any other orifice by means of said distribution member 10.

For its part, the refrigerant follows the same circulation path as in the first operating mode, in the first variant described, the only difference being that said refrigerant circulates in said second bypass branch 310c, said third expansion member 317 being open and active.

When the refrigerant returns to the main loop downstream of said third valve 320c, it thus splits between said main loop 300a, to enter said two-fluid exchanger 204, and said second bypass branch 310c, to enter said second interior exchanger 308, before converging

As in the preceding operating mode, by virtue of said refrigerant circuit 300, the heat released by the first heat transfer fluid into said refrigerant, in said two-fluid exchanger 204, is dissipated into the exterior air stream E in said second exterior exchanger 306. In parallel, in said second interior exchanger 308, the interior air stream I is cooled by releasing its heat into said refrigerant.

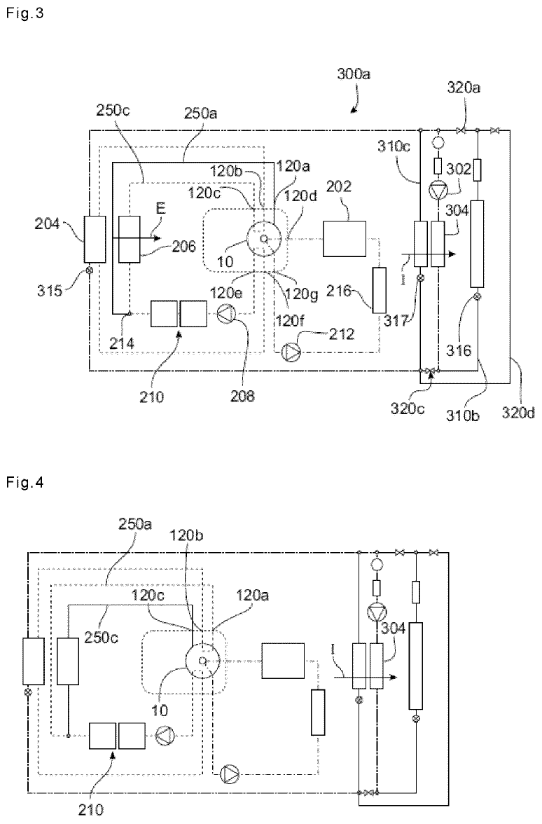

In FIG. 3, the operating mode shown makes it possible to heat the passenger compartment by releasing heat from the refrigerant into the interior air stream I through the first interior exchanger 304. Said heat preferably originates from the recovery of heat coming from the electrical system exchanger 210 and, by means of the first exterior exchanger 206, from the exterior air stream E, which is at a sufficient temperature, via the first heat transfer fluid and the two-fluid exchanger 204.

More specifically, in this third operating mode, in a first sub-circuit of said first circuit 200 of first heat transfer fluid, starting from the sixth distribution orifice 120g, the first heat transfer fluid is driven by the second pump 212, and passes through said electric heat exchanger 216 and said electrical energy storage system heat exchanger 202 before returning to the distribution system 100 by the first distribution orifice 120d. In the angular position in question, said distribution member 10 directly connects said first distribution orifice 120d to the sixth distribution orifice 120g. Said first sub-circuit thus allows self-heating of the storage system, the first heat transfer fluid circulating in a closed loop without passing through a heat exchanger, which would lead to undesirable dissipation of the heat released by said storage system. If necessary, said electric heat exchanger 216 is active in order to accelerate the heating of said storage system via the first heat transfer fluid and said electrical energy storage system exchanger 202.

In a second sub-circuit of said first circuit 200 of first heat transfer fluid, starting from the fourth distribution orifice 120e, the first heat transfer fluid is driven by the first pump 208, passes through said electrical system exchanger 210, passes through said divergence point 214, and then takes the third branch 250c to pass through said first exterior heat exchanger 206 before returning to the distribution system 100 by the third distribution orifice 120c. In the angular position in question, said distribution member 10 connects said third distribution orifice 120c to the second distribution orifice 120b. The first heat transfer fluid then continues its route, passing through said two-fluid exchanger 204 to return to said distribution system 100 by the fifth distribution orifice 120f. In the angular position in question, said distribution member 10 connects said fifth distribution orifice 120f to the fourth distribution orifice 120e to form said second sub-circuit. Such circulation allows the heat recovery mentioned above.

Even more specifically, such an operating mode is advantageously used when the temperature of the first heat transfer fluid is below a temperature threshold and the temperature of the exterior air stream E is above this temperature threshold, in which case the first exterior heat exchanger 206 allows the first heat transfer fluid to recover heat from said exterior air stream E, which is warmer.

In this third operating mode, as in the preceding modes, it will be understood that the first heat transfer fluid does not circulate in said seventh branch 250a, the seventh distribution orifice 120a not being connected to any other orifice by means of said distribution member 10. For its part, the refrigerant, starting from the compressor 302, circulates solely along the main loop 300a. In other words, on leaving the compressor 302, it passes through said first interior exchanger 304, condensing and dissipating its heat into said interior air stream I, thus heating the passenger compartment. It then passes through the first expansion member 315, which is active, and said two-fluid exchanger 204, evaporating under the effect of the heat released by said first heat transfer fluid. Said refrigerant then returns to the compressor 302 for another cycle. To this end, here, said third valve 320c is open and said first valve 320a and/or said second expansion member 316, or even said second valve 320b, are closed, so that the refrigerant does not circulate in either said first or the third bypass branch 310b, 310d. It will further be noted that said refrigerant does not circulate in said second bypass branch 310c, said third expansion member 317 being closed. As a variant, such circulation can take place with expansion of said refrigerant in said third expansion member 317 with a view to dehumidifying the interior air stream.

In FIG. 4, the operating mode is identical to the preceding mode apart from in that the first heat transfer fluid passes through the seventh branch 250a instead of the third branch 250c. To this end, here, in the angular position in question, said distribution member 10 connects the second distribution orifice 120b and the seventh distribution orifice 120a instead of the third distribution orifice 120c.

In this fourth operating mode, the passenger compartment is heated by releasing heat from the refrigerant into the interior air stream I through the first interior exchanger 304. In this case, said heat originates solely from the recovery of heat coming from the electrical system exchanger 210. This operating mode is advantageously used to replace the preceding mode when the temperature of the exterior air stream E is insufficient, particularly when it is below said temperature threshold. The rest of the operation is preferably unchanged.

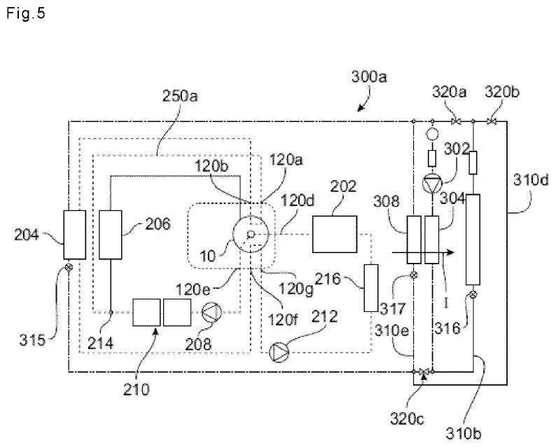

In FIG. 5, the operating mode shown makes it possible to heat the passenger compartment by releasing heat from the refrigerant into the interior air stream I through the first interior exchanger 304. Said heat preferably originates from the recovery of heat coming from the electrical energy storage system exchanger 202 and from the electrical system exchanger 210, via the first heat transfer fluid and the two-fluid exchanger 204.

More specifically, in this fifth operating mode, the first heat transfer fluid circulates once more in a single loop, but a different loop from the one in the second operating mode. Starting from the sixth distribution orifice 120g, the first heat transfer fluid is driven by the second pump 212, passes through said electric heat exchanger 216, which is active or inactive, and said electrical energy storage system heat exchanger 202 before returning to the distribution system 100 by the first distribution orifice 120d. In the angular position in question, said distribution member 10 connects said first distribution orifice 120d to the fourth distribution orifice 120e. The first heat transfer fluid is then driven by the first pump 208, passes through said electrical system exchanger 210, passes through said divergence point 214, and then takes the seventh branch 250a to bypass said first exterior heat exchanger 206 before returning to the distribution system 100 by the seventh distribution orifice 120a. In the angular position in question, said distribution member 10 connects said seventh distribution orifice 120a to the second distribution orifice 120b and said first heat transfer fluid then continues its route by passing through said two-fluid exchanger 204 to return to said distribution system 100 by the fifth distribution orifice 120f. In the angular position in question, said distribution member 10 connects said fifth distribution orifice 120f to the sixth distribution orifice 120g to form said corresponding single loop.

For its part, the refrigerant, starting from the compressor 302, circulates along the main loop 300a. In other words, on leaving the compressor 302, it passes through said first interior exchanger 304, condensing and dissipating its heat into said interior air stream I, thus heating the passenger compartment. It then passes through the first expansion member 315, which is active, and said two-fluid exchanger 204, evaporating under the effect of the heat released by said heat transfer fluid. Said refrigerant then returns to the compressor 302 for another cycle. To this end, here, said third valve 320c is open and said first valve 320a and/or said second expansion member 316, or even said second valve 320b, are closed, so that the refrigerant does not circulate in either the first or the third bypass branch 310b, 310d. In addition, said refrigerant circulates in said second bypass branch 310c, said third expansion member 317 being open and active with a view to dehumidifying the interior air stream I by means of heat exchange between said refrigerant and said interior air stream in said second interior exchanger 308, which dries said interior air stream I, taking the heat that it contains. As a variant, such circulation in said second bypass branch 310c does not take place, said third expansion member 317 being closed.

As stated above, the preceding operating modes, although advantageous, are given solely by way of example, and the device according to the invention allows numerous other modes, particularly by virtue of said multi-way distribution system 100.

1. A thermal regulation device comprising a circuit of first heat transfer fluid, said circuit of first heat transfer fluid comprising a system for distributing said first heat transfer fluid having a plurality of orifices for distributing said first heat transfer fluid, said circuit of first heat transfer fluid further comprising a plurality of branches respectively connected to one of said distribution orifices, said distribution system being intended to place at least some of said branches in communication with each other according to different configurations of said system, said distribution system comprising a distribution member, said distribution member being intended to be able to rotate about a longitudinal axis in order to selectively feed said branches to be placed in communication with each other as a function of angular positions of said distribution member,
a first of said branches comprising a heat exchanger, referred to as the electrical energy storage system heat exchanger,
a second of said branches being connected to a so-called two-fluid exchanger, intended to exchange heat with a refrigerant,
a third of said branches comprising an exchanger referred to as the first exterior exchanger, intended to exchange heat with a second heat transfer fluid,
a fourth of said branches comprising a first pump and, optionally, a heat exchanger, referred to as the electrical system heat exchanger,
a fifth of said branches being connected to said two-fluid exchanger,
a sixth of said branches comprising a second pump said circuit of first heat transfer fluid being configured to dissipate or supply heat in said electrical energy storage system exchanger or, if applicable, said electrical system exchanger, using only one and/or the other of said two pumps and heat exchange in said two-fluid exchanger and/or said first exterior exchanger.

2. The device as claimed in claim 1, wherein said circuit of first heat transfer fluid is configured so that said first fluid circulates from and to the distribution system, passing through said two-fluid exchanger without passing through one of the pumps.

3. The device as claimed in claim 1, wherein said circuit of first heat transfer fluid is configured so that one of the angular positions of the distribution member referred to as the first position, makes it possible to form a first loop comprising said first, second, fifth, and sixth branches and a second loop comprising said third and fourth branches.

4. The device as claimed in claim 1, wherein said first branch or said sixth branch further comprises a so-called electric heat exchanger, intended to heat said first fluid using an electric current.

5. The device as claimed in claim 1, wherein said device is configured so that said sixth branch supplies said first branch with first heat transfer fluid in all of the angular positions of said distribution member.

6. The device as claimed in claim 1, claims, wherein a seventh of said branches is configured to bypass the third branch.

7. The device as claimed in claim 6, wherein said device comprises a divergence point, situated at a first end of said fourth branch, said first end of the fourth branch being opposite a second end of said fourth branch connected to said distribution system, said divergence point being connected to said third branch and to said seventh branch.

8. The device as claimed in claim 1, comprising a refrigerant circuit wherein said refrigerant circuit comprises said two-fluid exchanger.

9. The device as claimed in claim 8, wherein said refrigerant circuit comprises a main loop comprising, in a direction of circulation of said refrigerant in said main loop a compressor an exchanger, referred to as the first interior exchanger, and said two-fluid exchanger, said device being configured so that said first heat transfer fluid is a cooling liquid and said second heat transfer fluid is a first air stream, referred to as the exterior air stream, said first interior exchanger being intended to exchange heat between said refrigerant and a second air stream, referred to as the interior air stream.

10. The device as claimed in claim 1, wherein said distribution member comprises a body having:
a first fluid distribution channel extending axially along the longitudinal axis and
a first chamber in communication with said first distribution channel, said first chamber opening radially,
such that angular positions of said body determine a passage for the fluid between a so-called axial inlet and/or outlet channel and at least one from among so-called peripheral inlet and/or outlet channels of the distribution system, through the first chamber and the first distribution channel.

11. The device as claimed in claim 2, wherein said circuit of first heat transfer fluid is configured so that one of the angular positions of the distribution member, referred to as the first position, makes it possible to form a first loop comprising said first, second, fifth, and sixth branches and a second loop comprising said third and fourth branches.

12. The device as claimed in claim 2, wherein said first branch or said sixth branch further comprises a so-called electric heat exchanger, intended to heat said first fluid using an electric current.

13. The device as claimed in claim 2, wherein said device is configured so that said sixth branch supplies said first branch with first heat transfer fluid in all of the angular positions of said distribution member.

14. The device as claimed in claim 2, wherein a seventh of said branches is configured to bypass the third branch.

15. The device as claimed in claim 2, comprising a refrigerant circuit, wherein said refrigerant circuit comprises said two-fluid exchanger.

16. The device as claimed in claim 2, wherein said distribution member comprises a body having:
a first fluid distribution channel extending axially along the longitudinal axis, and
a first chamber in communication with said first distribution channel, said first chamber opening radially,
such that angular positions of said body determine a passage for the fluid between a so-called axial inlet and/or outlet channel and at least one from among so-called peripheral inlet and/or outlet channels of the distribution system, through the first chamber and the first distribution channel.

17. The device as claimed in claim 3, wherein said first branch or said sixth branch further comprises a so-called electric heat exchanger, intended to heat said first fluid using an electric current.

18. The device as claimed in claim 3, wherein said device is configured so that said sixth branch supplies said first branch with first heat transfer fluid in all of the angular positions of said distribution member.

19. The device as claimed in claim 3, wherein a seventh of said branches is configured to bypass the third branch.

20. The device as claimed in claim 2, comprising a refrigerant circuit, wherein said refrigerant circuit comprises said two-fluid exchanger.
